(19) United States
(12) Patent Application Publication
(10) Pub. No.: US 2024/0300322 A1
(43) Pub. Date: Sep. 12, 2024

(54) FUEL SYSTEM FOR A PRESSURE TANK AND FOR A GAS-POWERED VEHICLE

(71) Applicant: Voith Patent GmbH, Heidenheim (DE)

(72) Inventors: Hartmut Frenz, Donzdorf (DE); Stefan Krapp, Aalen (DE)

(21) Appl. No.: 18/574,882

(22) PCT Filed: Jun. 27, 2022
(86) PCT No.: PCT/EP2022/067471

§ 371 Date: Dec. 28, 2023

(30) Foreign Application Priority Data
Jun. 28, 2021 (DE) 10 2021 116 567.9

(51) Int. Cl. B60K 15/03

(52) U.S. Cl. CPC B60K 15/03006; B60K 2015/03026; B60K 2015/03315

(57) ABSTRACT

A fuel system for installation in a hydrogen-powered vehicle and for one or more hydrogen pressure tanks configured for a high pressure level of at least 200 bar, includes connections for input and output lines and at least the following internal components: a pressure reducer, a gas filter, a shut-off valve, a vent valve, an overpressure safety valve and a pressure sensor. The pressure reducer is a two-stage pressure reducer which reduces the pressure of the hydrogen from the high pressure level from the pressure tank to a medium pressure level between 3 bar and 30 bar. The first stage reduces the pressure from the pressure tank to an intermediate level between 40 and 80 bar and the second stage further reduces the pressure to the medium pressure level. The internal components and gas lines interconnecting these internal components are disposed in an integral and self-supporting modular unit.

The invention relates to a fuel system intended for installation in a hydrogen-powered vehicle and for one or more hydrogen pressure tanks designed for a high pressure level of at least 200 bar, wherein the fuel system comprises a connection for an input line, a connection for an output line and a pressure reducer, and wherein the pressure reducer is designed such that it can reduce the pressure of the hydrogen from the high pressure level from the pressure tank to a medium pressure level of between 3 bar and 30 bar.

Hydrogen-powered vehicles have, for example, a gas engine or a fuel cell with an electric motor as the drive. In order to be able to store enough fuel, the hydrogen is stored in the tank under high pressure. Pressures of above 200 bar, often 350 bar or 700 bar and sometimes even up to 875 bar, are typical of such pressure tanks. Since the gas engine or the fuel cell is operated at a relatively low input pressure, the pressure has to be reliably adjusted from the high pressure level to a low pressure level.

Fuel systems for hydrogen pressure tanks and for installation in hydrogen-powered vehicles are known from the prior art. Examples are described, for example, in DE102019200459 A1 and in DE 102017214184 A1. The pressure level is reduced from the tank pressure to the required lower pressure level for a fuel cell by way of a pressure reducer. A control device and a pressure sensor on the pressure tank may be used to determine the filling level and communicate with a fueling station. Furthermore, the fuel system has shut-off valves and pipelines, which are connected via corresponding screw arrangements. If several pressure tanks are connected in parallel, they are accompanied by distribution points for the various tank lines. All these components and connecting points have to be tested and checked after installation. This produces considerable expenditure and entails risks in respect of incorrect fitting and corresponding leakage.

The object of the invention is to further develop and improve a fuel system for a hydrogen-powered vehicle so that it can be operated in a reliable and safe manner and can be fitted quickly and without faults.

The object is achieved by a fuel system according to claim 1. Further advantageous features are specified in the dependent claims.

According to the invention, the fuel system according to claim 1 is distinguished in that it comprises at least the following internal components:
a pressure reducer, a gas filter, a shut-off valve, a vent valve, an overpressure safety valve and a pressure sensor, wherein the pressure reducer is designed as a two-stage pressure reducer in such a way that it reduces the pressure from the pressure tank to an intermediate level of between 40 bar and 80 bar in the first stage and further reduces the pressure to the medium pressure level in the second stage, and wherein the internal components and gas lines, which connect these internal components to each other, are arranged in an integral and self-supporting unit.

The medium pressure level particularly preferably lies between 10 and 25 bar. More precise pressure setting is possible using a two-stage pressure reducer.

In order to make the fuel system more reliable and safer during operation, it comprises yet further components in addition to the pressure reducer, including a vent valve, via which the system can be flushed, for example after servicing work, a gas filter, which keeps relatively small impurities out of the pressure tank and thus ensures high-purity hydrogen, as is required for a relatively long service life of a fuel cell, a shut-off valve, with which the fuel system can be shut off from the fuel cell or the gas engine, an overpressure safety valve, which protects the fuel system against excessively high pressures and which is preferably arranged downstream of the pressure reducer in the throughflow direction, and a pressure sensor for measuring the state of the hydrogen gas. These measurement values can be used—possibly together with measurement values from sensors on the pressure tank—to more reliably and more accurately determine how much hydrogen there is in the pressure tank. This is important information for calculating the range of a vehicle and for the fueling process.

In addition, all the internal components, and corresponding gas lines which connect the internal components to each other, are arranged in an integral and self-supporting unit. This has the advantage that the fuel system according to the invention can be preassembled as an assembly independently of the vehicle and independently of the pressure tank. This fuel system, which is preassembled as an assembly, can then also be tested and approved in respect safety and quality in advance. As a result, the fuel system can be offered as a self-contained assembly for the first time. Installation in the vehicle is less complicated since only a few connections still have to be connected and all internal components and connections have already been tested for function and leakage. Fastening is easier since the self-supporting unit requires only a few fastening points and can be fitted as an assembly. In addition, the number of screw connections in the entire fuel system is considerably reduced.

The integral, self-supporting unit can preferably be entirely or partially designed with a diecast aluminum housing. Valve seats and/or ducts, for example, can be integrated in the housing as gas lines. The openings or cavities required for fitting valves or for fitting other components can be closed off by seals and covers. The integral, self-supporting unit can also be composed of several parts. For example, a sub-unit can be designed with a diecast aluminum housing and further components are fastened to this sub-unit. However, according to the invention, there are no screwed, exposed pipelines between the parts or the components in order to not adversely affect the reliability and simple assembly.

In a further embodiment according to the invention, the fuel system further comprises, as internal components, a second vent valve, wherein preferably both vent valves are connected to a common flushing line which leads through the housing to the outside. In particular, one vent valve is arranged upstream of the pressure reducer and the other vent valve is arranged downstream of the pressure reducer. Therefore, both the high-pressure side and also the medium-pressure side can be reliably flushed. In addition, yet further vent valves can also be provided, in particular when using a two-stage pressure reducer.

It is further advantageous when at least one non-return valve and a distribution system to several tank lines are provided as internal components, wherein the tank lines lead to the outside and wherein a connection is provided for each pressure tank. Owing to the additional integration of the distribution system and the non-return valve on the input side into the unit and thus into the assembly of the fuel system, the expenditure on assembly and testing of the vehicle is yet further reduced. The majority of connecting points and screw connections are therefore arranged inside the fuel system and have already been assembled and tested when the assembly is installed in the vehicle. Furthermore, it is advantageous when the tank nozzle is directly connected to the input line and is therefore part of the fuel system. Fitting in the vehicle is yet further simplified as a result.

The pressure reducer can preferably be adjusted to the respective, desired pressure level by means of spring loading.

In order to avoid excessively large changes in temperature given relatively high volume flows through the fuel system and given severe changes in pressure, it may be advantageous when a cooling device is provided on the pressure reducer. The cooling device can preferably be designed as a heat exchanger with ducts through which fluid flows. These ducts can be provided in the common housing or made in the common housing. In particular, this heat exchanger can be designed such that it can be connected to a coolant system of the vehicle.

In a preferred embodiment, the fuel system additionally comprises an electronic tank control unit, which is fastened to the unit and is supported by it, wherein the tank control unit is suitable for receiving and for processing at least the signals from the sensors that are provided on the fuel system and for generating one or more output signals. Owing to the integration of the fuel system of the electronic tank control unit into the fuel system, the assembly can be tested more comprehensively in advance and yet fewer interfaces have to be taken into consideration during fitting in the vehicle. The cable harness between the tank control unit and the sensors in the unit can therefore also be integrated and supported by the unit.

The tank control unit is further improved if it is configured such that it can receive a temperature sensor signal from each pressure tank and in particular if it can also still receive a pressure sensor signal from each pressure tank. The filling level of the pressure tank can be calculated more accurately and more reliably as a result.

The tank control unit can additionally be configured such that it can communicate with a hydrogen fueling station, and in particular can control a fueling process.

In a particularly preferred embodiment, a temperature sensor is provided as an internal component. The temperature sensor can be used to monitor the state of the hydrogen and, under certain conditions, to calculate the quantity of hydrogen.

In particular, a simplified embodiment can have advantages since it is more cost-effective and contains fewer components. With this embodiment according to the invention, the fuel system comprises, as internal sensors, only precisely one pressure sensor and precisely one temperature sensor, in each case upstream of the pressure reducer.

In a further advantageous embodiment, a further second pressure sensor and/or a further second temperature sensor are provided as internal components, wherein preferably one pressure sensor and one temperature sensor are arranged upstream of the pressure reducer and one pressure sensor and one temperature sensor are arranged downstream of the pressure reducer. Owing to these additional sensors, determination of the states of the through-flowing hydrogen gas can be detected more precisely and thus the quantities of hydrogen are calculated more precisely and more reliably. In addition, malfunctions or leakages can be better identified, this increasing the safety of the system.

As an enhancement, a hydrogen purity sensor can further be provided as an internal component. This hydrogen purity sensor is preferably arranged downstream of the pressure reducer in the throughflow direction. This additional sensor can be used to ensure that, for example, a subsequent fuel cell also receives sufficiently clean hydrogen and thus the function of the fuel cell is maintained and its service life is extended. Any required servicing or required replacement of the gas filter is identified in good time.

The internal components are particularly preferably arranged in the following order from the input line to the output line in the throughflow direction: gas filter, pressure reducer, vent valve, overpressure safety valve, shut-off valve. Further internal components provided can be arranged between these components or upstream or downstream thereof. The cited order provides particularly good functionality.

An embodiment of the invention in which the unit is composed of several sub-units, which are fastened to one another such that they form a self-supporting unit, is also included.

In particular, the unit can comprise a sub-unit, which has a housing, preferably composed of a cast aluminum material, in which at least the following internal components are arranged: the pressure reducer, the pressure sensor, the vent valve, the overpressure safety valve and the shut-off valve. In this context, “arranged” means that, in the case of the valves and very particularly in the case of the shut-off valve, it suffices when at least the valve seat is arranged in the sub-unit.

Furthermore, it is advantageous when the unit has a substantially prismatic shape with two end sides, wherein the end sides are preferably of triangular or preferably parallelogram-like design. Owing to this shape of the unit, the fuel system can be accommodated in a space-saving manner between the pressure tanks on the vehicle. The pressure tanks are elongate and cylindrical, and therefore the unit, by way of its triangular or parallelogram-like cross-sectional shape, can be very readily arranged in the gaps between the pressure tanks, without additional installation space being required.

In this context, in addition to an exact triangle, a triangular end side is also understood to mean a situation where the boundary lines of the triangle are slightly curved or designed with individual projections or recesses. It is critical in this context for the end sides to substantially resemble a triangular shape. The same analogously applies to the parallelogram-like end sides.

In particular, it is advantageous for the connection for the input line and/or the connection for the output line to each be arranged on one of the end sides. As a result, they are readily accessible and can be easily fitted and serviced.

In order to allow further simplified assembly, it is advantageous when the unit has fastening options by means of which the fuel system can be fitted to a supporting structure, which fastens the pressure tanks in the vehicle. In this way, the fuel system may be fastened to a tank module, which comprises a supporting structure and several pressure tanks, and already be connected to the tank lines of the pressure tank. The tank module including the fuel system is then installed in the vehicle as a complete unit. The assembly time on the vehicle manufacturer's production line is therefore further minimized, this constituting a major advantage.

Further advantageous features of the invention are explained using exemplary embodiments with reference to the drawings. The cited features can advantageously be implemented not only in the illustrated combination but also individually combined with one another. Specifically:

FIG. 1 is a schematic illustration of a fuel system according to the invention,

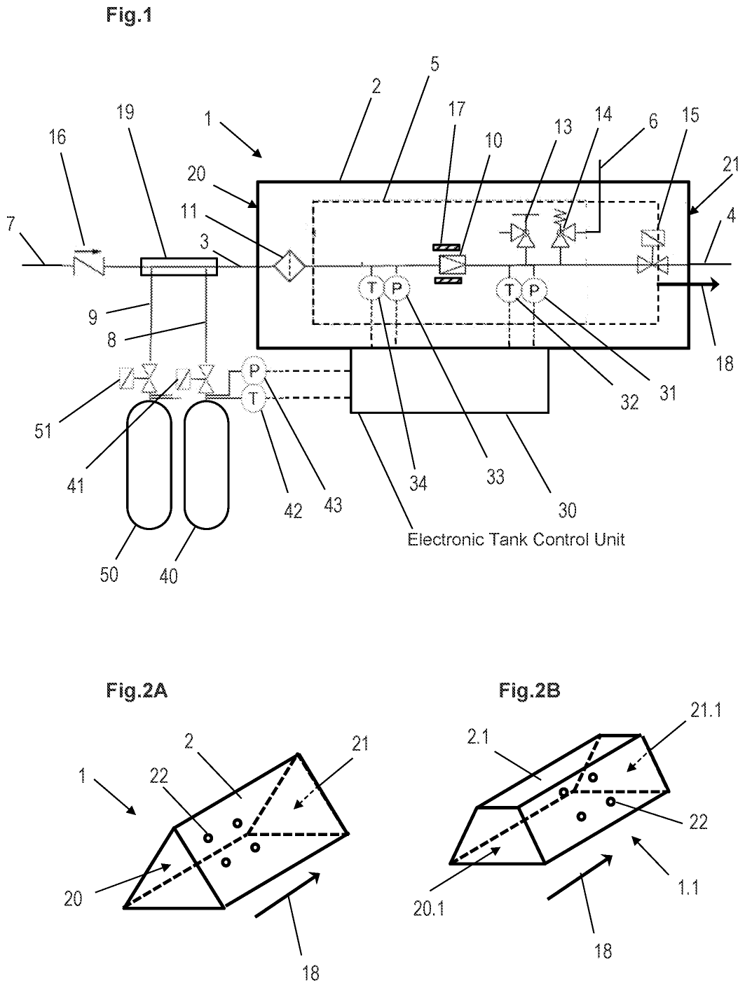

FIGS. 2a, b are examples of the geometric shape of the housing, and

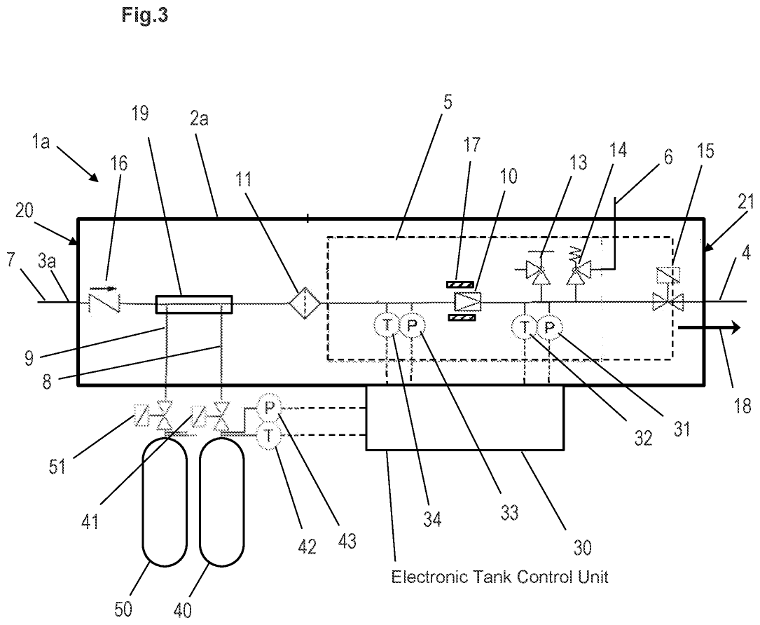

FIG. 3 shows a further fuel system according to the invention.

The figures will be described in more detail below. The same reference numerals denote identical or analogous parts or components.

FIG. 1 schematically shows an embodiment according to the invention of a fuel system 1 for a hydrogen-powered vehicle. The size ratios and the position with respect to the pressure tanks 40, 50 are not to scale. In this embodiment, the fuel system 1 is connected via the input line 3 to the distributor 19, which firstly connects the tank lines 8, 9 and secondly the tank nozzle 7 to the fuel system 1. Only two pressure tanks 40, 50 are shown by way of example, but several pressure tanks can also be connected.

The pressure reducer 10, which is of two-stage design, the gas filter 11, the vent valve 13 and also the overpressure safety valve 14 and the shut-off valve 15 are provided upstream of the output line 4 as internal components. All of these internal components are installed in or on the integral and self-supporting unit 2. The throughflow direction from the input line 3 to the output line 4 is denoted 18. A consumer, such as a fuel cell or a gas engine for example, can be connected to the output line 4. Furthermore, at least one pressure sensor 31, 33 and at least one temperature sensor 32, 34 are provided as internal components.

The fuel system is more reliable owing to the use of the cited internal components and the integration into a unit 2. The fuel system 1 can be fitted and tested for function and leakage in advance as a unit 2, so that, when the vehicle is assembled, the fuel system can be fitted as one assembly with few interfaces very much more quickly and reliably than in the case of previous fuel systems. In addition, only these few interfaces then still also have to be checked for leaktightness.

Several of the internal components can be arranged in a housing as a sub-unit, as illustrated here. The further components or sub-units are connected to this sub-unit such that they form the unit 2. The housing 5 of the sub-unit is preferably produced from a cast aluminum material. In the embodiment shown, this sub-unit comprises the pressure reducer 10, the vent valve 13, the overpressure safety valve 14 and the shut-off valve 15. In addition, the sub-unit optionally comprises pressure and temperature sensors and also possibly the cooling device 17, if provided. In particular, the housing 5 can be designed as a main body of the sub-unit, the required valve seats, openings or cavities for the sensors and also the gas lines, for example in the form of flow-optimized ducts, being incorporated into the main body.

The shut-off valve 15 is preferably designed as an electromagnetic valve. The pressure reducer 10 is adjusted to the desired pressure level in two stages and preferably with spring loading. The vent valve 13 has a flushing line, which leads through the housing to the outside, this only being indicated in the case of valve 13 in the drawing. The vent valve 13 is preferably designed as a manual valve since it is required only during start-up or servicing work.

The overpressure safety valve 15 protects the medium-pressure side of the fuel system, that is to say the region in the throughflow direction downstream of the pressure reducer 10, against excessively high pressures. The overpressure safety valve leads into a relief line 6, which passes to the outside and can be connected to the line outside a hose or a further line, for safe discharge of the hydrogen gas in the event of an emergency.

Additionally, the electronic tank control unit 30, which can be fastened to the unit 2, is optionally provided in this embodiment. As an alternative, the tank control unit can also be arranged in the unit 2 as an internal component. The tank control unit 30 processes the signals from the internal sensors and additionally the signals from the external sensors, here those from the pressure sensors 43 etc. and those from the temperature sensors 42 etc. on the individual pressure tanks 40, 50 for example. Reliable calculation of the tank filling levels and the hydrogen consumption levels is possible as a result. The tank control unit 30 can output, for example, the tank filling levels, a range or the like as an output signal. In addition, the tank control unit can optionally communicate with a hydrogen fueling station, so that the fueling process runs in an optimum manner, or the tank control unit can control the fueling process in communication with the fueling station. In addition, the tank control unit is connected to a fuel cell or a gas engine in order to exchange information and signals.

Additionally, a second pressure sensor 31, 33 and/or a second temperature sensor 32, 34 can be installed as internal components, as shown. Calculations of the tank filling levels, communication with a fueling station and monitoring of the leaktightness and also identification of malfunctions are further improved as a result.

A cooling device 17, which serves to prevent excessively large changes in temperature on account of pressure release from the hydrogen at the pressure reducer 10, can be provided in the region of the pressure reducer 10.

The input line 3 and the output line 4 are preferably provided on opposite end sides 20, 21 of the housing 2. This leads to the fuel system 1 being able to be of slim design and the connections for the tank nozzle 7 and for the fuel cell or for the gas engine having enough space.

FIGS. 2a and 2b show schematically simplified possible forms of integral and self-supporting units 2, 2.1. The end faces are triangular 20, 21 in one case and parallelogram-like 20.1, 21.1 in one case. In both cases, the end faces are also understood to mean faces with curved edges or with projections or recesses, as already described above. The purpose of the shaping is that the fuel system 1, 1.1 can be arranged between the cylindrical pressure tanks in a space-saving manner. The fastening options 22 on one of the side faces of the unit 2, 2.1 in each case are also shown. The fuel system 1, 1.1 can be fitted to a supporting structure, which supports the pressure tanks and is fastened to the vehicle, via the fastening options 22. Beyond the unit forms shown, further similar forms are feasible, these being suitable for the fuel system to be able to be arranged in the gaps between the pressure tanks without an additional space requirement.

FIG. 3 shows a further embodiment of the fuel system 1a according to the invention. The variants shown differ from the embodiment shown in FIG. 1 in that the distributor 19 to the tank lines 8, 9 and the at least one non-return valve 16 are additionally arranged on the unit 2a as internal components. As a result, there are yet fewer interfaces that have to be taken into consideration and checked when assembling the vehicle. In particular, the tank nozzle 7 can be directly fastened to the unit 2a and supported by it.

The temperature sensor 34 and/or the pressure sensor 33 can advantageously also be positioned on the distributor 19 in this embodiment.

As a preferred embodiment, the housing 5 can be produced as a main body for the sub-unit, in particular as a diecast aluminum component, in which the required valve seats, openings or cavities for the sensors and also the gas lines, for example in the form of flow-optimized ducts, are incorporated. If the housing is of multipart design, it is important that there are no free pipelines between the parts, but rather that the parts are directly connected, for example screwed, to each other.

Only two pressure tanks are shown by way of example once again. Several tank lines and several pressure tanks can also be connected here.

### LIST OF REFERENCE SIGNS

1, 1a, 1.1 Fuel system
2, 2a, 2.1 Integral and self-supporting unit
3, 3a Input line
4 Output line
5 Housing sub-unit
6 Relief line
7 Tank nozzle
8, 9 Tank line
10 Pressure reducer
11 Gas filter
13 Vent valve
14 Overpressure safety valve
15 Shut-off valve
16 Non-return valve
17 Heating device or cooling device
18 Throughflow direction
19 Distributor
20, 20.1, 21, 21.1 End sides
22 Fastening options
30 Tank control unit
31,33 Pressure sensor
32, 34 Temperature sensor
40,50 Pressure tank
41,51 Tank valve
42 Temperature sensor
43 Pressure sensor

1-14 (canceled)

15. A fuel system for installation in a hydrogen-powered vehicle and for one or more hydrogen pressure tanks configured for a high pressure level of at least 200 bar, the fuel system comprising:
a connection for an input line;
a connection for an output line;
internal components including at least a pressure reducer, a gas filter, a shut-off valve, a vent valve, an overpressure safety valve and a pressure sensor;
said pressure reducer configured to reduce a pressure of hydrogen from a pressure tank being at a high pressure level to a medium pressure level of between 3 bar and 30 bar;
said pressure reducer being configured as a two-stage pressure reducer having a first stage reducing the pressure from said pressure tank to an intermediate level of between 40 and 80 bar, and a second stage further reducing the pressure to the medium pressure level;
gas lines interconnecting said internal components; and
an integral and self-supporting unit, said internal components and said gas lines being disposed in said integral and self-supporting unit.

16. The fuel system according to claim 15, which further comprises a plurality of tank lines leading out of said integral and self-supporting unit, said internal components including a non-return valve and a distribution system leading to said plurality of tank lines, and connections provided for each of the hydrogen pressure tanks.

17. The fuel system according to claim 15, wherein said integral and self-supporting unit includes a tank nozzle.

18. The fuel system according to claim 15, which further comprises a cooling device disposed on said pressure reducer.

19. The fuel system according to claim 15, wherein said pressure sensor is one of a plurality of sensors, an electronic tank control unit is fastened to and supported by said integral and self-supporting unit, and said tank control unit is configured for receiving and for processing signals from said plurality of sensors for generating one or more output signals.

20. The fuel system according to claim 19, wherein said tank control unit is configured to at least one of receive a temperature sensor signal from each of the pressure tanks or receive a pressure sensor signal from each of the pressure tanks.

21. The fuel system according to claim 19, wherein said tank control unit is configured to at least one of communicate with a hydrogen fueling station or control a fueling process.

22. The fuel system according to claim 15, wherein said internal components include a temperature sensor.

23. The fuel system according to claim 22, wherein said internal components include only one pressure sensor and one temperature sensor each disposed upstream of said pressure reducer as internal sensors.

24. The fuel system according to claim 22, wherein said internal components include at least one of a further pressure sensor or a further temperature sensor as internal components.

25. The fuel system according to claim 24, wherein one of said pressure sensors and one of said temperature sensors are disposed upstream of said pressure reducer, and another of said pressure sensors and another of said temperature sensors are disposed downstream of said pressure reducer.

26. The fuel system according to claim 15, wherein said internal components include a hydrogen-purity sensor.

27. The fuel system according to claim 15, wherein said internal components are disposed in order from said connection for said input line to said connection for said output line in a throughflow direction as follows:
said gas filter, said pressure reducer, said vent valve, said safety valve and said shut-off valve.

28. The fuel system according to claim 15, wherein said integral and self-supporting unit is formed of a plurality of sub-units being fastened to one another to form a self-supporting unit.

29. The fuel system according to claim 15, wherein said integral and self-supporting unit includes a sub-unit having a housing, and at least said pressure reducer, said pressure sensor, said vent valve, said overpressure safety valve and said shut-off valve are disposed in said housing.

30. The fuel system according to claim 29, wherein said housing is formed of a cast aluminum material.

31. The fuel system according to claim 15, wherein said integral and self-supporting unit has fastenings configured to fasten the fuel system to a supporting structure fastening the pressure tanks in the vehicle.
